(19) United States
(12) Patent Application Publication
(10) Pub. No.: US 2005/0130052 A1
(43) Pub. Date: Jun. 16, 2005

(54) Toner and method of preparing the same

(76) Inventor: Koichi Tsunemi, Suwon-si (KR)

Correspondence Address: STANZIONE & KIM, LLP, 1740 N STREET, N.W., FIRST FLOOR, WASHINGTON, DC, 20036, US

(21) Appl. No.: 11/007,290

(22) Filed: Dec. 9, 2004

(30) Foreign Application Priority Data
Dec. 12, 2003 (JP) 2003-90553

(51) Int. Cl. G03G 9/08

(52) U.S. Cl. 430/108.4; 430/137.2; 430/137.18; 430/108.1; 430/108.8; 430/108.6; 430/108.7; 430/126

(57) ABSTRACT

A toner prepared using a master batch of a wax and a colorant such that it has an excellent dispersion of colorant and wax, a high concentration, a good color development and a broad range of color reproducibility. By performing a non-magnetic development using this toner, an image of high quality can be formed.

### CROSS-REFERENCE TO RELATED APPLICATIONS

This application claims the benefit of Korean Patent Application No. 2003-90553, filed on Dec. 12, 2003, in the Korean Intellectual Property Office, the disclosure of which is incorporated herein in its entirety by reference.

### BACKGROUND OF THE INVENTION

1. Field of the Invention

The present general inventive concept relates to a toner and a method of preparing the same, and more particularly, to a color toner used with an electrophotographic image forming process and a method of preparing the same.

2. Description of the Related Art

In general, an electrophotographic image forming process is as follows.

First, after a surface of a photoreceptor is electrophotographically and uniformly charged, a laser beam is irradiated onto the surface of the photoreceptor. In the area irradiated by the laser beam, positive and negative charges-are generated and move toward the surface of the photoreceptor. As the charges on the surface become neutral, the potential of the surface changes, thus forming a latent image.

Then, through a developing process using a toner having a predetermined color, an image is formed on the surface of the photoreceptor. The image is then transferred onto a surface of a receptor, such as a sheet of paper or intermediate transfer medium.

The electrophotographic image forming process is classified into a dry process using a solid toner and a liquid process using a liquid toner.

In general, a solid toner, especially a solid color toner, is prepared by forming a master batch which comprises resins and colorants and has a concentration of pigments of around 40%, adding additives, such as charge control agents, thereto and subsequently kneading, milling, and classifying the mixture.

However, the solid color toner prepared by the above process has a poor dispersion of colorants, especially, pigments, and thus, may not achieve a sufficient concentration of pigments even though the amount of pigments is increased. Also, there is a problem in obtaining an image of high quality since aggregates of the pigments are misdistributed on the toner surface.

### SUMMARY OF THE INVENTION

Accordingly, the present general inventive concept provides a toner by which an image of high concentration can be formed, the toner having a good color development and a broad range of color reproducibility, a method of preparing the toner, and an apparatus and method of forming an electrophotographic image using the toner.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of preparing a toner, the method comprising: forming a master batch by mixing a wax and a colorant and heating and cooling the master batch to provide solidification; adding a binder and a charge control agent to the master batch and heating a resultant product to melt-knead it; cooling and solidifying the resultant product and pulverizing it to obtain powders, and classifying the powders; and adding an additive to the classified powders.

The present general inventive concept also provides a toner having an average particle diameter of 3.5 to 12 μm, prepared by the above method.

The foregoing and/or other aspects and advantages of the present general inventive concept are also achieved by providing an electrophotographic image forming apparatus comprising: a photoreceptor unit including a photosensitive drum and an electrophotographic photoreceptor; a charging unit to charge a surface of the photosensitive unit; an imagewise light irradiating device to expose the surface of the charged photoreceptor unit corresponding to an image pattern to form an electrostatic latent image thereon; a developing unit comprising at least a developing roller and a layer regulating blade, to develop the electrostatic latent image with a toner having an average particle diameter of 3.5 to 12 μm prepared by the above method, to form a toned image on the surface of the photosensitive unit; and a transfer unit to transfer the toned image to a receptor.

The foregoing and/or other aspects and advantages of the present general inventive concept are also achieved by providing an electrophotographic image forming method comprising: charging a surface of an organic photoreceptor having a conductive substrate; exposing the charged surface of the organic photoreceptor to disperse the charges in the exposed region and form a pattern of charged and uncharged regions; forming a toned image on the surface by applying a toner prepared by the above method to the surface of the organic photoreceptor; transferring the toned image onto a surface of a receptor; and repeating the above operations for a predetermined number of times.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating an electrophotographic image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

First, according to an embodiment of the present general inventive concept, a master batch of wax and colorant is formed by mixing the wax and the colorant in a predetermined mixing ratio, followed by heating, cooling for solidification, and pulverizing the resultant product.

Any colorant generally used in preparing a toner may be used in the present general inventive concept. Specific examples of the colorants that may be used include carbon black as a black pigment, PY17, PY74, PY180 as yellow pigments, PB15:3, PB15, PB4, PG7 as cyan pigments, and PR122, PR57:1, PR146 as magenta pigments, and so on.

Any wax generally used in preparing a toner may be used in the present general inventive concept. Specific examples include natural waxes, for example, castor wax, rice wax, and hydrocarbon wax, and polyethylene wax, polypropylene wax, polyethylene derivative wax, polypropylene derivative wax and mixtures thereof. Among the hydrocarbon waxes, Fischer-Tropsch wax may be used.

The wax can be converted by heating it to a liquid form having a low viscosity at the temperature of 100 to 150° C. After the conversion, the pigment may be dispersed in the wax by applying a shear force by a shear force machine to the pigment, at a temperature in which the wax can be maintained in a liquid form. Next, the wax, in which the pigment is dispersed, is cooled to provide solidification to obtain a master batch.

During the formation of the master batch, the colorant and the wax may be mixed in a weight ratio of 20:80 to 80:20, especially 40:60 to 70:30. If the amount of the pigment is less than the above range, a sufficient shear force may not be applied to the master batch. If the amount of the wax is more than the above range, a poor dispersion appears.

In the next step, a binder and a charge control agent are added to the pigment/wax master batch. Then, the resultant product is heated to be melt-kneaded. Generally, during the kneading, a twin-screw extruder, a Kneadex, a Banbury mixer and so on are used. The toner materials melt-kneaded as such are cooled to provide solidification and roughly pulverized in particles with a size of 0.2 to 2 mm, especially about 1 mm, and further pulverized in particles with a finer particle size. Then, only powders having an average particle diameter of 5 to 10 μm are collected through a classification process. Whereas a speed mill, Rotplex mill and so on, which are generally used in the conventional art, are used in the rough pulverization process of the present general inventive concept, a so-called mechanical mill having a rotor and a stator may be used in the fine pulverization process, rather than a collision-type mill in a view of the performance of toner.

In the classification process, not only a conventional wind energy classifier, but also an elbow jet-type classifier using the Coanda effect and a mechanical classifier which can efficiently classify fine powders by a rotor rotating at a high speed of 200 to 3000 rpm may be used.

Any binder generally used in preparing a toner may be used. Specific examples of the binder include styrene acrylate, polyester, poly-p-chlorostryrene, poly-α-methylstyrene, styrene-chlorostyrene copolymer, styrene-ethylene acrylate coplymer and so on. The amount of the binder may be 12.5 to 100 parts by weight, based on 1 part by weight of the colorant. As the binder, a resin having an acid number of not more than 20 mgOH/g may be used.

As non-limiting examples of the charge control agent, azo based dyes, salicyclic acid derivatives and other metal complexes and so on may be used. The amount of the charge control agent may be 0.1 to 8.0 parts by weight, based on the total weight of the toner components. If the amount of the charge control agent is less than 0.1 part by weight, the effect of its addition is too weak. If the amount is more than 8.0 parts by weight, the charge may become unstable.

Finally, as mentioned above, various additives are externally added to the finely pulverized toner to obtain the toner according to the present general inventive concept.

In the external addition process, fine particles of surface-treated silica are mostly used. But, various types of silica may be added, which have different particle diameters, specific surface area, or have been subjected to different surface treatments. Also, as the additives, surface-treated titanium oxide, cerium oxide, stearates may be used. If such additives are used, charge performance may be improved. The total amount of the additives may be 0.01 to 5.0 parts by weight, based on the total weight of the toner.

In the above external addition process, a Henschel Mixer or a Loedige Mixer which allows a high speed shearing operation and so on may be used. But, it is preferable in a view of dispersion to use a mixer of which a mixing chamber has a substantially spherical inner side.

For the toner prepared according to an embodiment of the present general inventive concept, it is possible to use a so-called mono component developing system in which a developer is comprised of a toner, not including a carrier, rather than a two-component developing system in which a mixture of carrier and toner is used.

In an embodiment of the present general inventive concept, the mono component developing system can be adopted. According to the mono component developing system, a developing unit is provided with at least both a developing roller and a layer regulating blade to form a uniform layer of toner on the developing roller. As the layer regulating blade, a metal plate, an L-shaped blade with its tip bent in an L-shape which regulates a layer with a corner portion, a blade to which materials, for example, resins, such as silicone and polyurethane, or elastic rubbers are arranged and fixed, can be used.

As the layer regulating blade, a blade which regulates a layer by coming into contact with a toner, especially, an L-shaped blade, may be used.

The toner according to an embodiment of the present general inventive concept has a higher and better level of dispersion of the wax and the pigment than a conventional toner, thus increasing a probability that the wax and the pigment will be exposed on the surface of the toner. If a high line pressure is applied to the toner by means of materials such as a resin or an elastic rubber, the wax or pigment migrates to the portion of a resin or rubber of the blade with high line pressure, resulting in loss of capability of regulating a layer. Thus, it is impossible to stably print out an image of high quality.

Furthermore, as the developing roller, an elastomer-coated roller which is coated with a film of elastomer, such as silicone rubber, urethane rubber and NBR(Nitrile Butadiene Rubber) having a thickness of about 1 to 3 mm, an elastic roller which is a combination of a metal shaft and an elastomer, a metal roller or a metal roller coated with a resin or a conductive paint can be used. In the developing unit, a feeding roller is arranged in contact with a developing roller. Any feeding roller generally used in forming an electrophotographic image may be used, for example, an elastic roller or an elastic foam roller.

After developing the photoreceptor, the toner is transferred to a receptor, such as a sheet of paper or other recording medium, and fixed to the receptor by heat fixing.

In the fixing process, various fixing units can be used. When using the toner according to an embodiment of the present general inventive concept, it is not necessary to apply oil to prevent offset to a heating means facing the toner due to a good dispersion of the pigment and the wax according to the present embodiment. Accordingly, a good fixing property can be obtained just by contacting the toner with a conventional oil-free type of roller or resin film.

It is possible to use an organic photoreceptor as the photoreceptor according to another embodiment of the present general inventive concept, since an organic photoreceptor has a surface comprising resins, such as polycarbonates, and it is possible to avoid the problems that occur when an inorganic photoreceptor is used, i.e., that the inorganic photoreceptor is subjected to abrasion during its use and a portion of the toner components becomes attached to the abrasion site, resulting in deterioration of the performance of the toner.

The photoreceptor used in the present embodiment may include a single layer or multiple layers, and may be positively or negatively charged. Refreshing a surface by abrasion of the photoreceptor has especially a considerable effect on the organic photoreceptor having a relatively smaller diameter. The range of the substantial diameter of a photosensitive drum may be not more than 25 mm, and particularly 30 to 12 mm.

The diameter of the developing roller may be 20 to 60% of that of the photoreceptor. If the diameter of the developing roller is too high, abrasion of a photoreceptor is accelerated and thus the refreshing effect may not be achieved, which is not desired.

The developing roller is arranged opposite to the photoreceptor with the layer(s) of the toner interposed between them. Here, a contact developing method in which a photoreceptor is substantially in contact with a developing roller, or a non-contact developing method in which a photoreceptor is substantially apart from a developing roller by a gap of 50 to 1000 μm, and particularly 100 to 500 μm may be used. It is preferable to use a contact developing method in view of image quality.

As the charging method, a non-contact charging method using wires, such as a scorotron, and a contact charging method in which a charging roller is directly in contact with a photoreceptor can be used, but the charging method described above is not limited thereto.

The toner prepared as described above in a previous embodiment has an average particle diameter of 3.5 to 12 μm and has a good colorant dispersion. When forming an electrophotographic image using the toner described above, excellent image resolution, gradation, color reproducibility, fixing property and so on may be achieved.

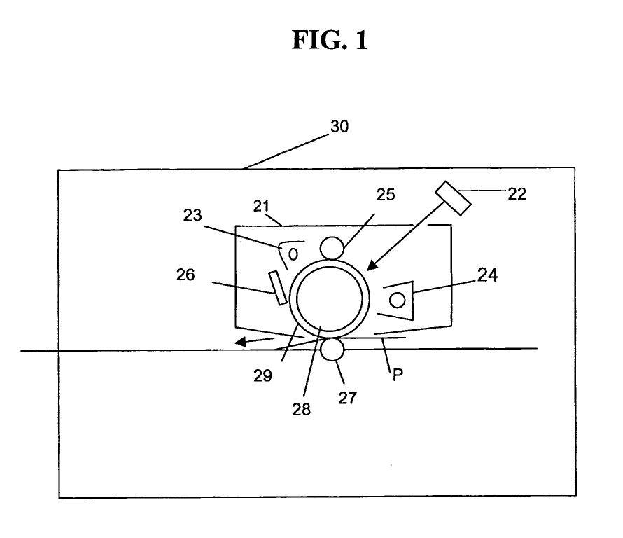

Referring to FIG. 1, an image forming apparatus 30 according to an embodiment of the present general inventive concept will be described in detail.

An electrophotographic cartridge 21 includes an electrophotographic photoreceptor 29, at least one charging unit 25 to change the photoreceptor 29, a developing unit 24 to develop an electrostatic latent image formed on a surface of the photoreceptor 29, and a cleaning unit 26 to clean the surface of the photoreceptor 29. The electrophotographic cartridge 21 is attachable to or detachable from the image forming apparatus 30.

The image forming apparatus 30 includes a photoreceptor unit including an electrophotographic photosensitive drum 28 and the electrophotographic photoreceptor 29 formed on the electrophotographic photosensitive drum 28; the charging unit 25 to change the photosensitive unit; a light exposure unit 22 to expose the surface of the charged photoreceptor unit corresponding to an image pattern to form an electrostatic latent image thereon; the developing unit 24 to develop the electrostatic latent image with the toner described in a previous embodiment of the present general inventive concept, to form a toned image on the surface of the photoreceptor unit; and a transfer unit 27 to transfer the toned image to a receptor, for example, a sheet of paper P or other image recording medium. Voltage is applied to the charging unit 25, and the charging unit 25 comes in contact with and charges the electrophotographic photoreceptor 29. The image forming apparatus 30 may include a pre-exposure unit 23 to eliminate a remaining charge on the surface of the electrophotographic photoreceptor 29, to start a subsequent cycle.

An electrophotographic image forming method according to an embodiment of the present general inventive concept, in which the toner according to a previous embodiment is used, will now be explained in detail.

First, a surface of an organic photoreceptor formed on a conductive substrate is electrophotographically and uniformly charged. The charged surface is exposed to light corresponding to an image pattern, and thus the surface charges are selectively dispersed in the exposed area, thereby patterning the charged and uncharged areas. Finally, the toner is attached to the surface to form a toned image on the surface of the substrate. The toned image formed is transferred to a suitable surface of a receptor, such as a sheet of paper. The image forming process is repeatedly carried out several times.

Hereafter, the method according the present embodiment will be described by presenting the following experimental examples. However, the present embodiment is not limited to these experimental examples.

### EXAMPLE 1

Hydrocarbon wax having a melting temperature of 80±3° C., synthesized by the Fischer-Tropsch method is melted at 110° C. to change it into a liquid form. Yellow pigment PY180, cyan pigment PB15:3, and magenta pigment PR146 are respectively mixed into the obtained liquid. In this case, the weight ratio of the pigment and wax is adjusted to 67:33. Dispersion of the mixture can be carried out by a high-speed shear force disperser (8000 to 23000 rpm). After cooling, the mixtures are respectively pulverized to obtain a master batch of wax and pigment.

6 parts by weight of the yellow, cyan and magenta master batches obtained according to the above procedure are respectively mixed with 92 parts by weight of polyester resin (Mw=150,000, Mw/Mn is at least 4, acid value is not more than 5) and 2 parts by weight of aluminium centered metal negative charge control agent. Then, the resulting mixtures are melt-kneaded by using a twin-screw extruder.

The materials melt-kneaded according to the above procedure are respectively pulverized by a mechanical mill. Subsequently, the powders are classified into powders having an average particle diameter of about 6.8 μm by a classifier using the Coanda effect.

Thereafter, 1.5 parts by weight of silica having a specific surface area of 300 m² as measured by the BET method and surface-treated with oil, 0.5 part by weight of silica having a specific surface area of 120 m² as measured by the BET method and treated with a silane coupling agent and 0.3 parts by weight of titanium oxide surface-treated for hydrophobization are added to the respective powders in a mechanical mixer which has a substantially spherical inner side. After mixing, a color toner having an average particle diameter of about 6.8 μm is obtained.

A photosensitive drum having a diameter of about 20 mm is used. The developing unit was provided with a developing roller which has a diameter of about 10 mm and an axis of 5 mm and is coated with an elastic rubber with a thickness of 2.5 mm. A layer regulating blade made of stainless steel and having a tip bent by 1 mm to an angle of 90° is used so that a corner of the layer regulating blade comes in contact with the developing roller to perform a layer regulating. Also, a feeding roller is arranged with the developing roller.

The contact developing method in which a photoreceptor is substantially in contact with a developing roller is carried out.

Upon reviewing the operation conditions of the developing process, the charge potential of the photoreceptor is set to −600 V, the potential of post-exposure is −50 V, the bias potential applied to the developing roller is −300 V and the bias potential applied to the feeding roller is −450 V.

The mentioned developing units are arranged so that yellow, cyan, magenta and black colors are developed in this sequence.

Black toner prepared by a conventional method is introduced into the same type of developing unit that is provided with yellow, cyan and magenta toners. A so-called tandem bicycle type printer is constructed by arranging the photoreceptor and the developing unit for each color in series. Transferring and fixing are carried out on a sheet of paper in turn to obtain a full-color image. The image has a good image resolution, gradation, color reproducibility and fixing property, which allows a high quality image even after 5000 sheets of paper are printed.

### EXAMPLE 2

Hydrocarbon wax having a melting temperature of 85±3° C., synthesized by the Fischer-Tropsch method is melted at 120° C. to change it into a liquid form. Yellow pigment PY74, cyan pigment PB15:3 and magenta pigment PR57:1 are respectively mixed into the obtained liquid. In this case, the weight ratio of the pigment and wax is adjusted to 60:40. Dispersion of the mixtures can be carried out by a high-speed shear force disperser (8000 to 23000 rpm). After cooling, the mixtures are respectively pulverized to obtain a master batch of wax and pigment.

Six parts by weight of the yellow, cyan and magenta master batches are respectively mixed with 92 parts by weight of polyester resin (Mw/Mn is at least 10, acid value is not more than 5) and 2 parts by weight of aluminium centered metal negative charge control agent. Then, the resulting mixtures can be melt-kneaded by using a twin-screw extruder. The materials melt-kneaded according to the above procedure are respectively pulverized by a mechanical mill to obtain powders. Subsequently, the powders are classified into powders having a average particle diameter of about 6.2 μm by a classifier which operates by a rotor rotating at a high speed.

Thereafter, 1.5 parts by weight of silica having a specific surface area of 300 m² as measured by the BET method and surface-treated with a siliane coupling agent and oil, 0.5 parts by weight of silica having a specific surface area of 50 m² as measured by the BET method and treated with a silane coupling agent and 0.5 part by weight of titanium oxide surface-treated for hydrophobization, are externally added to the respective powders in a mechanical mixer which has a substantially spherical inner side. After mixing, a color toner having an average particle diameter of about 6.2 μm is obtained.

A photosensitive drum having a diameter of about 25 mm is used. The developing unit was provided with a developing roller which has a diameter of about 10 mm and an axis of 9 mm and is coated with an elastic rubber in thickness of 2 mm. A layer regulating blade made of stainless steel and having a tip bent by 1 mm to an angle of 90° is used so that a corner of the layer regulating blade comes into in contact with the developing roller to perform a layer regulating. Also, a feeding roller is arranged with the developing roller.

The non-contact developing method in which a photoreceptor is substantially apart from a developing roller by a gap of 200 μm is carried out.

Upon reviewing the operation conditions of the developing process, the charge potential of the photoreceptor is set to −700 V, the potential of post-exposure is set to −50 V, the bias potential applied to the developing roller is set to −300 V, the frequency of the alternating components is set to 2 kHz and the bias potential applied to the feeding roller is set to −450 V.

The above mentioned developing units are arranged so that yellow, cyan, magenta and black colors can be developed in this sequence. Black toner prepared by a conventional method can be introduced into the same type of developing unit that is provided with yellow, cyan and magenta toners. A so-called tandem bicycle type printer is constructed by arranging the photoreceptor and the developing unit for each color in series. Transferring and fixing are carried out on a sheet of paper in turn to obtain a full-color image. The image has a good image resolution, gradation, color reproducibility and fixing property, which allow a high quality image even after 5000 sheets of paper are printed.

Comparative Experiment

Yellow pigment PY180, cyan pigment PB15:3, and magenta pigment PR146 were respectively mixed with polyester resin (Mw/Mn is at least 4, acid value is not more than 5) in a weight ratio 40:60. Then, they were sufficiently heated and kneaded with a 3-roll roller. After cooling, they were respectively pulverized to obtain a master batch of resin and pigment.

Ten parts by weight of the yellow, cyan and magenta master batches (the final concentration of the pigment was 4%) were respectively mixed with 86 parts by weight of polyester resin (Mw/Mn is at least 4, acid value is not more than 5), 2 parts by weight of hydrocarbon wax, having the melting temperature of 80±3° C. synthesized, by the Fischer-Tropsch method, and 2 parts by weight of aluminium centered metal negative charge control agent. Then, the resulting mixtures were respectively melt-kneaded by using a twin-screw extruder. The materials melt-kneaded according to the above procedure were respectively pulverized by a mechanical mill. Subsequently, the powders were classified into powders having an average particle diameter of 6.5 μm by means of a classifier using the Coanda effect.

Thereafter, 1.5 parts by weight of silica having a specific surface area of 300 m² as measured by the BET method and surface-treated with oil, 0.5 part by weight of silica having a specific surface area of 120 m² as measured by the BET method and treated with a silane coupling agent and 0.3 part by weight of titanium oxide surface-treated for hydrophobization, are externally added to the respective powders in a mechanical mixer which has a substantially spherical inner side. After mixing, a color toner having an average particle diameter of about 6.5 μm was obtained.

A photosensitive drum having a diameter of about 20 mm was used. The developing unit was provided with a developing roller (a diameter of 10 mm) having an axis of 5 mm and coated with an elastic rubber in thickness of 2.5 mm.

A layer regulating blade made of stainless steel and having a tip bent by 1 mm to an angle of 90° was used so that a corner thereof came in contact with the developing roller to perform a layer regulating. Also, a feeding roller was arranged with the developing roller.

The contact developing method in which a photoreceptor is substantially in contact with a developing roller was carried out.

The charge potential of the photoreceptor was set to −600 V, the potential of post-exposure was to −50 V, the bias potential applied to the developing roller was to −300 V and the bias potential applied to the feeding roller was to −450 V. The mentioned developing units were arranged so that yellow, cyan, magenta and black colors might be developed in this sequence. Black toner prepared by a conventional method was introduced into the same type of developing unit that was provided with yellow, cyan and magenta toners. A so-called tandem bicycle type printer was constructed by arranging the photoreceptor and the developing unit for each color in series. Transferring and fixing were carried out on a sheet of paper in turn to obtain a full-color image. The obtained image had less gradation and color reproducibility than those according to the embodiments of the present general inventive concept described supra. The printed image had a reduced concentration and resolution after 2000 sheets of paper were printed.

The electrophotographic toner according to an embodiment of the present general inventive concept may be used to form an electrophotographic image. The toner has an excellent dispersion of colorant and wax, a high concentration, a good color development and a broad range of color reproducibility. By performing a non-magnetic development using the toner according to an embodiment of the present general inventive concept described supra, an image of high quality may be formed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of preparing a toner, comprising:
forming a master batch by mixing a wax and a colorant, and heating and cooling the master batch to provide solidification;
adding a binder and a charge control agent to the master batch and heating a resultant product to melt-knead the master batch;
cooling and solidifying the resultant product and pulverizing it to obtain powders, and classifying the powders; and
adding an additive to the classified powders.

2. The method of claim 1, wherein the wax is one or more selected from a group consisting of castor wax, rice wax, hydrocarbon wax, polyethylene wax, polypropylene wax, polyethylene derivative wax and polypropylene derivative wax.

3. The method of claim 1, wherein in forming the master batch, the colorant and the wax are mixed in a weight ratio of 80:20 to 20:80.

4. The method of claim 1, wherein in pulverizing, a mechanical mill having a rotor and a stator is used.

5. The method of claim 1, wherein adding the additive is performed in a chamber which has a substantially spherical inner side.

6. The method of claim 1, wherein the additive is one or more selected from a group consisting of silica, titanium oxide, cerium oxide and stearates.

7. A toner having an average particle diameter of 3.5 to 12 μm, prepared by the following method:
forming a master batch by mixing a wax and a colorant, and heating and cooling the master batch to provide solidification;
adding a binder and a charge control agent to the master batch and heating a resultant product to melt-knead the master batch;
cooling and solidifying the resultant product and pulverizing it to obtain powders, and classifying the powders; and
adding an additive to the classified powders.

8. A toner according to claim 7, wherein the wax is one or more selected from a group consisting of castor wax, rice wax, hydrocarbon wax, polyethylene wax, polypropylene wax, polyethylene derivative wax and polypropylene derivative wax.

9. A toner according to claim 7, wherein in forming the master batch, the colorant and the wax are mixed in a weight ratio of 80:20 to 20:80.

10. A toner according to claim 7, wherein in pulverizing, a mechanical mill having a rotor and a stator is used.

11. A toner according to claim 7, wherein adding the additive is performed in a chamber which has a substantially spherical inner side.

12. A toner according to claim 7, wherein the additive is one or more selected from a group consisting of silica, titanium oxide, cerium oxide and stearates.

13. An electrophotographic image forming apparatus comprising:
a photoreceptor unit including an electrophotographic photosensitive drum and an electrophotographic photoreceptor;
a charging unit to charge a surface of the photoreceptor unit;
an imagewise light irradiating device to expose the surface of the charged photoreceptor unit corresponding to an image pattern to form an electrostatic latent image thereon;
a developing unit comprising at least a developing roller and a layer regulating blade, to develop the electrostatic latent image with the toner having an average particle diameter of 3.5 to 12 μm, to form a toned image on the surface of the photosensitive unit, the toner being prepared by forming a master batch by mixing a wax and a colorant, and heating and cooling the master batch for solidification, adding a binder and a charge control agent to the master batch and heating a resultant product to melt-knead it, cooling and solidifying the resultant product and pulverizing it to obtain powders, and classifying the powders, and adding an additive to the classified powders; and
a transfer unit to transfer the toned image to a receptor.

14. The electrophotographic image forming apparatus of claim 13, wherein the range of the diameter of the photosensitive drum is not more than 20 mm .

15. The electrophotographic image forming apparatus of claim 13, wherein the diameter of the developing roller is 20 to 60% of that of the photosensitive drum.

16. The apparatus of claim 13, wherein the wax is at least one selected from a group consisting of castor wax, rice wax, hydrocarbon wax, polyethylene wax, polypropylene wax, polyethylene derivative wax and polypropylene derivative wax.

17. The apparatus of claim 13, wherein in forming the master batch, the colorant and the wax are mixed in a weight ratio of 80:20 to 20:80.

18. The apparatus of claim 13, wherein in pulverizing, a mechanical mill having a rotor and a stator is used.

19. The apparatus of claim 13, wherein adding the additive is performed in a chamber which has a substantially spherical inner side.

20. The apparatus of claim 13, wherein the additive is at least one selected from a group consisting of silica, titanium oxide, cerium oxide and stearates.

21. An electrophotographic image forming method comprising:
charging a surface of an organic photoreceptor having a conductive substrate;
exposing the charged surface of the organic photoreceptor to disperse the charges in the exposed region and form a pattern of charged and uncharged regions;
forming a toned image on the surface of the conductive substrate by applying the toner on the surface of the organic photoreceptor, the toner being prepared by forming a master batch by mixing a wax and a colorant, and heating and cooling the master batch for solidification, adding a binder and a charge control agent to the master batch and heating a resultant product to melt-knead it, cooling and solidifying the resultant product and pulverizing it to obtain powders, and classifying the powders, and adding an additive to the classified powders;
transferring the toned image on the surface of a receptor; and
repeating the above operations for a predetermined number of times.

22. The method of claim 21, wherein the wax is at least one selected from a group consisting of castor wax, rice wax, hydrocarbon wax, polyethylene wax, polypropylene wax, polyethylene derivative wax and polypropylene derivative wax.

23. The method of claim 21, wherein in forming the master batch, the colorant and the wax are mixed in a weight ratio of 80:20 to 20:80.

24. The method of claim 21, wherein in pulverizing, a mechanical mill having a rotor and a stator is used.

25. The method of claim 21, wherein adding the additive is performed in a chamber which has a substantially spherical inner side.

26. The method of claim 21, wherein the additive is at least one selected from a group consisting of silica, titanium oxide, cerium oxide and stearates.

27. A method of preparing a toner, comprising:
forming a master batch by solidifying a mix of a wax, a colorant, a binder and a charge control;
pulverizing the master batch to obtain powders, and classifying the powders; and
adding an additive to the classified powders.

28. The method of claim 27, wherein the wax is one or more selected from a group consisting of castor wax, rice wax, hydrocarbon wax, polyethylene wax, polypropylene wax, polyethylene derivative wax and polypropylene derivative wax.

29. The method of claim 27, wherein in forming the master batch, the colorant and the wax are mixed in a weight ratio of 80:20 to 20:80.

30. The method of claim 27, wherein in pulverizing, a mechanical mill having a rotor and a stator is used.

31. The method of claim 27, wherein adding the additive is performed in a chamber which has a substantially spherical inner side.

32. The method of claim 27, wherein the additive is one or more selected from a group consisting of silica, titanium oxide, cerium oxide and stearates.

33. A toner having an average particle diameter of 3.5 to 12 μm, prepared by the following method:
forming a master batch by solidifying a mix of a wax, a colorant, a binder and a charge control;
pulverizing the master batch to obtain powders, and classifying the powders; and
adding an additive to the classified powders.
